(19) United States
(12) Patent Application Publication
(10) Pub. No.: US 2013/0211925 A1
(43) Pub. Date: Aug. 15, 2013

(54) USER-SELECTED ADVERTISEMENT LAYOUT

(71) Applicant: Robert W. Holland, Austin, TX (US)

(72) Inventor: Robert W. Holland, Austin, TX (US)

(21) Appl. No.: 13/414,878

(22) Filed: Mar. 8, 2012

Related U.S. Application Data
(63) Continuation-in-part of application No. 13/396,906, filed on Feb. 15, 2012.

(51) Int. Cl. G06Q 30/02

(52) U.S. Cl. 705/14.72

(57) ABSTRACT

An entertainment content consumer selects the manner in which advertisements are presented at a client by selecting one of plural available advertisement content layouts. Entertainment content is served to the entertainment content consumer's client with advertisement content by using the advertisement content layout selected by the consumer. For example, a consumer selects whether to have advertisements served within a social media news feed or to have advertisements served by a video shown over the social media news feed according to a predetermined metric, such as an advertisement at regular time intervals or predetermined download metrics. Empowering the consumer to control how advertisements are served improves the consumer's experience by providing fewer higher quality advertisements to the consumer for a given allocation of entertainment content viewing.

### RELATED APPLICATIONS

The present application is a continuation-in-part of co-pending U.S. patent application Ser. No. 13/396,906, entitled “User-Selected Advertisements” by Robert W. Holland, filed on Feb. 15, 2012, which is hereby incorporated by reference herein in its entirety as though fully set forth.

### BACKGROUND OF THE INVENTION

1. Field of the Invention

The present invention relates in general to the field of presenting advertisement content to an end user, and more particularly to user-selected advertisement layout.

2. Description of the Related Art

Consumers have come to expect free entertainment content presented on television and through the Internet. In fact, entertainment content is typically funded by advertisements presented during “commercial” breaks that interrupt the presentation of entertainment content. A typical television station channel has more than ten minutes of advertisement content per broadcast hour. A television channel typically pays an entertainment content owner for the right to present entertainment content, such as a movie or sitcom, and then sells advertising time during commercial breaks to retailers, manufacturers, political candidates, or whoever wants to communicate a message to consumers. The revenue from sales of advertising time pays for the entertainment content, the costs of broadcasting and, hopefully for the television station, a profit for the television station.

The exchange of entertainment content for consumer exposure to advertisements is often actively resisted by consumers. Rather than watching Company A's commercial during halftime, Joe Sixpack will head to the fridge for Company B's beer and not return until the sound of his game returns. In some instances, consumers will elect not to watch entertainment content because of the advertisements interspersed in the entertainment content. For example, a mother may forbid her children from watching an educational children's show because she does not want her children to see advertisements during commercial breaks that market sugar-laced breakfast cereals to children. When consumers do not view advertisements, advertisers get little value for their payments to broadcasters.

The Internet has changed the conventional television model for presenting advertisements during commercial breaks of entertainment content. For example, Web pages often have a number of different advertisements intermixed with entertainment content for presentation at a computer display concurrent with the entertainment content. The advertisements include, for example, banner, text, interstitial, pop-up, opt-in mailing, HTML, rich media, and sponsorship advertisements. One example of a typical Web page that presents entertainment content to a consumer with advertisement funding is a broadcast television news channel website, which allows a consumer to select a news story for presentation as a movie on the consumer's computer display. Banner advertisements surround a video window that presents the news story as a movie. Before the news story movie plays in the video window, an advertisement is presented as a movie in the video window. The consumer is therefore bombarded by a variety of advertisements using a variety of techniques in exchange for the content owner's approval for the consumer to watch the news story movie entertainment content. In theory, at least some of the consumer's attention is trained on at least some of the advertising content so that the advertiser gains some marketing value from the purchase of advertising space on the Web page. In fact, however, the effectiveness of such advertising is often questioned so that advertisers pay correspondingly lower fees for the news channel when the advertiser purchases advertising space on the Web page.

Internet and other media entertainment content providers have attempted to improve the effectiveness of advertising content at communicating a message by employing a number of different techniques. GOOGLE recently offered to pay consumers to load spyware on the consumer's computer so that GOOGLE can track inputs made by the consumer and content viewed by the consumer. Exact knowledge of a consumer's behavior helps the Internet content provider predict how the consumer (and other consumers by using modeling techniques) will use and view content so that advertisements are more accurately targeted towards the interests of consumers. Ideally, a well-targeted advertisement presented to a consumer at a Web page leads the consumer to interact with the advertiser to provide the advertiser with a direct lead to a consumer who is more likely to make a purchase. Unfortunately for advertisers, consumers generally do not like being spied upon so that the types of personal information that most accurately helps target advertisements at consumers is rarely available for advertisers.

On-demand entertainment content providers, such as HULU and NETFLIX, stream entertainment content, such as television sitcom shows and movies, to a consumer's computer or television through an Internet interface so the user can watch the content on demand. Recently, HULU offered consumers a chance to select one of three different advertisements so that the consumer would see the selected advertisement during a commercial break in presentation of entertainment content. In theory, the consumer pays more attention to an advertisement selected by the consumer because the consumer has a greater interest in the content of the selected advertisement. However, the consumer has to take the time before the presentation of the entertainment content to select an advertisement and the advertisement interrupts the presentation of the entertainment content similar to the commercial break of the conventional television advertising model. Selection by a consumer from a limited number of options of advertisements does not guarantee that the consumer will actually watch the advertisement during the commercial break.

Internet content providers struggle to make revenue by including advertisements in entertainment content. Generally, entertainment content consumers struggle to avoid viewing the advertisements. Advertisers pay less revenue to entertainment content providers when content-consumer conduct minimizes the impact of the advertiser's message. For example, advertisement content displayed along the border of entertainment content is often ignored or tuned out by entertainment content consumers. In contrast, advertisement content intermingled with entertainment content is more difficult for entertainment content consumers to ignore or tune out. Internet content providers earn more revenue from more intrusive advertisement content, such as advertisements intermingled with entertainment content; however, more intrusive advertisements tend to cause entertainment content consumers to tune out the Internet content provider by looking elsewhere for entertainment content.

One recent example of Internet content providers that face this advertisement dilemma is social media content providers, such as FACEBOOK. A social media website attracts a critical mass of entertainment content consumers by presenting user-generated entertainment content with less-intrusive advertisements. For instance, an entertainment content consumer receives a news feed of entertainment content consisting of social information input to the social media website by friends. Entertainment content in the form of real time updates of friends' social information is streamed into the middle of a website page viewed by the entertainment content consumer. While building a critical mass of entertainment content consumers, the social media website makes some advertisement revenue by presenting advertisement contents along the side border of the website page—a display location easily ignored by entertainment content consumers and held in low esteem by advertisers. Once the social media website has a critical mass of entertainment content consumers, it seeks to increase advertisement revenue by presenting advertisement content in display positions that are more prized by advertisers, such as by including advertisements intermittently in the entertainment content consumer's feed of social information from friends. The hope of the social media website is that the critical mass of friends will retain consumers despite the use of more intrusive advertisements that provide increased revenue.

A difficulty with presentation of advertisement content in more prominent display locations is that entertainment content consumers become annoyed by advertisement disruptions and either use the social media website less frequently or leave the social media website completely. Imagine, for example, the horror of a grandmother who calls up her social media webpage on her computer to show co-workers a picture of her grandchild when a “friend” advertisement for a bladder control diaper targeted at the grandmother streams into the middle of the webpage. Entertainment content consumers want the equivalent of a content free lunch, entertainment content providers want to earn revenue for providing a valuable service, and advertisers want an advertisement content message that effectively reaches entertainment content consumers.

### SUMMARY OF THE INVENTION

Therefore a need has arisen for a system and method which efficiently targets advertisement content to consumers.

A further need has arisen for a system and method which provides entertainment content consumers with positional and/or temporal control over advertisement content layout for advertisements presented to the consumer in exchange for entertainment content presented to the consumer.

In accordance with the present invention, a system and method are provided which substantially reduce the disadvantages and problems associated with previous methods and systems for targeting advertisement content to consumers. A consumer selects and views advertisement content in a transaction that is temporally separate from viewing by the consumer of entertainment content that the consumer earned authorization to view with the consumer's viewing of the advertisement content.

More specifically, an end user consumer having a client computer interfaces with a server at a first time period to retrieve advertisement contents for presentation at the client computer. A verifier running on the client computer uses sensors of the client computer to verify that that end user consumer has viewed advertisement content with at least a minimal level of attention and communicates verification to the server. The server stores points in memory and associates the points with the end user consumer to reflect point values of advertisement content viewed by the end user consumer. At a second time period independent of the first time period, the end user consumer selects entertainment content to view with the points earned from viewing the advertisement content at the first time period. The points stored in memory associated with the end user consumer are reduced by a point cost of the entertainment content selected by the end user and the entertainment content is presented to the end user at the second time period, such as without advertisement content included in the entertainment content or with a lesser amount of advertisement content, such as a banner that reminds the end user consumer of the advertising entity that is sponsoring the end user consumer's view of the entertainment content.

In accordance with another embodiment of the present invention, a system and method are provided which substantially reduce the disadvantages and problems associated with previous methods and systems for presenting advertisement content to entertainment content consumers. An entertainment content consumer selects an advertisement content layout from plural advertisement content layouts. The entertainment content consumer then retrieves entertainment content and advertisement content for presentation at a client with the selected advertisement content layout.

More specifically, a client interfaces with a server through the Internet to retrieve entertainment content from the server for presentation at the client, such as by interfacing with a social media website to retrieve a news stream for friends of an entertainment content consumer who is using the client. The client retrieves an advertisement content layout interface from the server that accepts a selection of an advertisement content layout for use at the client from plural available advertisement content layouts. An advertisement content layout engine coordinates downloading of entertainment content and advertisement content from the server to the client for presentation at the client with the advertisement content layout. The entertainment content consumer using the client is provided control over the temporal and/or positional presentation of advertisement content that the entertainment content consumer views in exchange for viewing entertainment content. For example, a default advertisement content layout includes advertisement contents on the border of a news feed from social media friends and also includes advertisement contents in the news feed. An alternative advertisement content layout available for selection by the entertainment content consumer alters the position of the advertisement contents by increasing the portion of the display that presents advertisement contents and decreasing the size of the portion of the display that presents entertainment content without inserting advertisement contents in the news feed. Another alternative advertisement content layout available for selection by the entertainment content consumer alters the temporal nature of advertisement content by presenting an advertisement movie in an advertisement video window presented over entertainment content and then presenting entertainment content for a predetermined time period or other metric without including advertisement content. The time (or other metric such as quantity of data downloaded) that an entertainment content consumer gets to view entertainment content without advertisements depends upon the type of advertisement contents viewed, such as the size of the video window, the length of the video, interaction with the advertiser associated with the video, verification of viewing the advertisement contents or other factors.

The present invention provides a number of important technical advantages. One example of an important technical advantage is that a consumer's most valuable asset is respected: the consumer's time. A consumer chooses what advertisement content to watch and when to watch it. The consumer then has the freedom to use the value created by the consumer from watching the advertisement content when and how the consumer wants to use the value. Rather than presenting a nuisance by interrupting entertainment content, advertisement content presents a value to the consumer by allowing the consumer to self-target advertisements for gathering information of interest to the consumer. Accurate targeting of advertisements means a greater value to advertisers so that a consumer needs to watch fewer advertisements in exchange for the privilege of watching a given entertainment content. Respect for the consumer's time extends to the consumer's personal space and privacy. Consumer consent by agreement to watch advertisements in exchange for the privilege of watching entertainment content means that a local advertisement analyzer running on the consumer's computer can gather information for targeting advertisements without exposing the information external to the consumer's computer. Market forces drive efficiencies in the presentation of advertisement content that are not possible in a conventional television advertisement-funded entertainment content model because consumers are motivated to watch relevant advertisements, advertisers are motivated to create relevant advertisements that a consumer will select to watch and entertainment content is directly purchased by consumers with advertisement views separate from the presentation of the entertainment content based on a price determined by the entertainment content owner.

Another advantage to the present invention is that advertising entities have an opportunity to populate a database of video advertisements readily searchable by a consumer and having a message that is controllable by the advertising entities. When consumers search the Internet using a conventional search engine, the consumers often arrive at conflicting and confusing information. In some instances, advertising entities will pay a premium to have a website show up at the top of a search, however, negative and sometimes false information about the advertising entity might also show up. The questionable results of search engines also affect consumers who tend to question the validity and authenticity of information from websites. By limiting the consumers' search to a database of paid advertisements, the consumer has greater comfort in relying upon information gleaned from the advertisements. Moreover, the consumer will have greater comfort initiating a direct interaction with the advertiser through advertisement content from a trusted source.

Another advantage to the present invention is that entertainment content consumers have improved satisfaction with an entertainment content provider due to the control that the entertainment content consumer exercises over presentation of advertisement content. Entertainment content consumers are subjected to fewer advertisements in exchange for viewing advertisements of more value to an advertiser. The improved experience of the entertainment content consumer increases the likelihood that the entertainment content consumer will use an entertainment content provider. For example, a social media website is more likely to retain consumers who are offended by insertion of advertisements in a news feed if the social media website provides consumers with alternative choices to viewing advertisements in a news feed, such as watching advertisement movies instead. The entertainment content consumer can select to view less advertisement content by providing attention to viewed advertisements that are valued more highly by advertisers, such as advertisements that provide advertisers with a direct lead. Advertisers focus a message with a greater likelihood of a direct lead interaction by an entertainment content consumer so that more relevant and useful information is conveyed to the consumer. Further advantages are provided where an entertainment content consumer selects advertisement content to view, as set forth in the related application hereto. Entertainment content providers, advertisers and consumers have less bandwidth consumed by reduced advertisement content downloads, which reduces the expense of communication of data, such as by consumers through a cell phone network.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for user-selected advertisements;

FIG. 2 depicts a flow diagram of a process for a user to select advertisements to earn points;

FIG. 3 depicts a flow diagram of a process for a user to select entertainment content by exchanging points earned from observing advertisement content.

FIG. 4 depicts a block diagram of a system for user-selected advertisement content layouts.

FIG. 5 depicts examples of advertisement content layouts selectable by an end user and

FIG. 6 depicts a flow diagram of a process for user-selected advertisement content layouts.

### DETAILED DESCRIPTION

Efficient self-targeted advertising temporally separates the value created by a consumer watching an advertisement from the value of entertainment content purchased by the consumer. The conventional advertisement-funded presentation of entertainment content is modified by allowing a consumer to earn points by selecting advertisement content the consumer wants to watch when the consumer wants to watch it, rather than attempting to force the consumer to watch advertisement contents interspersed during commercial breaks in entertainment content. The end user then gets to select and watch entertainment content uninterrupted by advertisement content by exchanging the points for a point cost of the entertainment content at a time convenient for the consumer to watch the entertainment content. In summary, the consumer looks at advertisements that both the consumer and an advertiser want the consumer to see when it is convenient for the consumer, and then the consumer gets to watch entertainment content that the consumer wants to watch that is indirectly paid for by the advertiser when the consumer wants to watch the entertainment content.

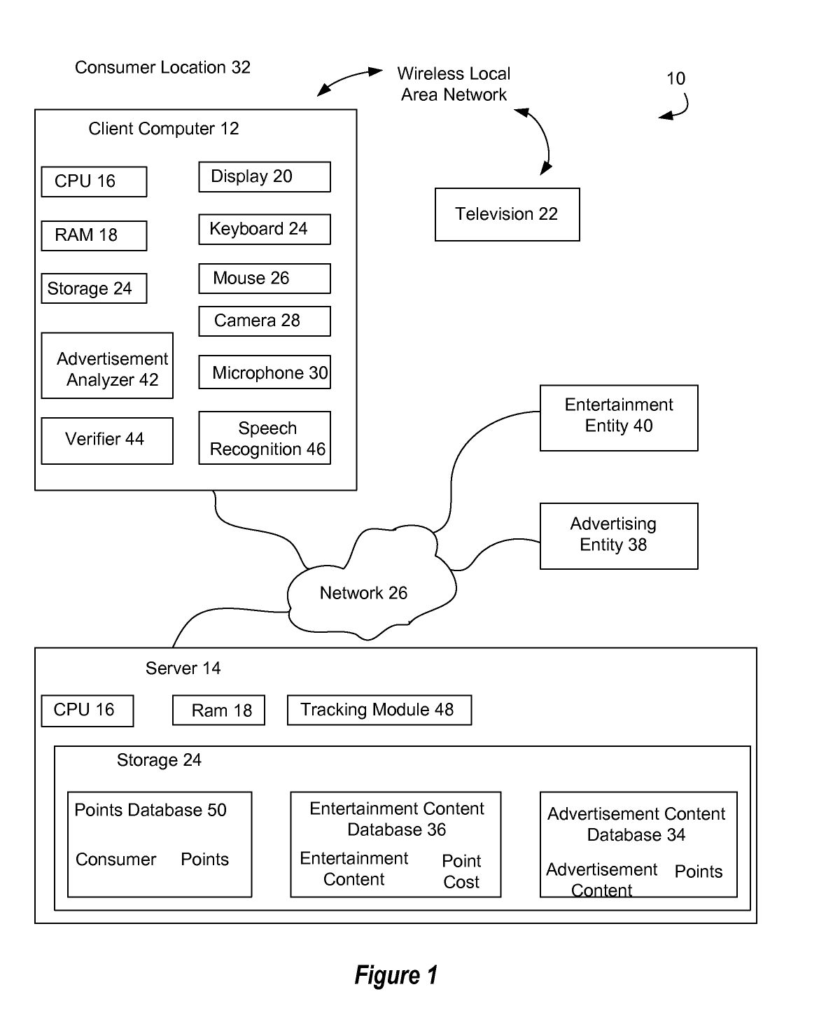

Referring now to FIG. 1, a block diagram depicts a system 10 for user-selected advertisements. Various embodiments of the system include computing devices, such as a client computer 12 and server computer 14, that process information with instructions executed on processors 16 and stored in memory 18. The instructions transform information into graphical images presented at a display 20, television 22 or other display device. The instructions store information in a variety of machine readable storage devices, such as DRAM, hard disk drives, solid state drives, optical drives or other types of storage devices. The instructions executed on processors 16 include instructions to communicate information over a network 26, such as the Internet, using a variety of communication protocols that stream information or copy files, such as TCP/IP, FTP, and other types of protocols. In the example embodiment depicted by FIG. 1, client computer 12 is a laptop, tablet or smartphone having a display 20 integrated in its housing. In alternative embodiments, other types of client computers may be used, including desktop computers, set top boxes used for communicating with a cable or satellite television provider, an optical drive player with an Internet interface or similar devices. Client computer 12 includes input devices to accept end user inputs, such as keyboard 24 and a mouse 26. Client computer 12 can also include other types of sensors, such as a web video camera 28 that captures images and a microphone 30 that captures audible sounds.

In the example embodiment depicted by FIG. 1, client computer 12 is located at a consumer location 32, such as a residence having a wireless local area network and interface with Internet 26. Client computer 12 interfaces through Internet 26 with server computer 14 to have access to plural advertisement contents in an advertisement content database 34 and to plural entertainment contents in an entertainment content database 36. In alternative embodiments, advertisement content may be distributed across plural network locations, such as at one or more advertisement entities 38 that desire to present advertisements to consumers. In alternative embodiments, entertainment content may be distributed across plural network locations, such as at one or more entertainment entities 40 that desire to sell entertainment content for presentation to consumers.

An end user consumer at consumer location 32 retrieves advertisement content from advertisement content database 34 through Internet 26 for presentation with client computer 12, such as at display 20 or television 22. To aid the selection of advertisement content from plural advertisement contents, an advertisement analyzer 42 executes on client computer 28 to analyze information input by the end user and determine interests of the end user. Unlike conventional spyware, advertisement analyzer 42 runs locally on client computer 12 without sending confidential or personal information to third parties. Advertisement analyzer 42 can run locally since the decision about what advertisements to present at client computer 12 is a decision made by the end user of client computer 12 instead of by a third party. Advertisement analyzer 42 presents suggestions to an end user of advertisements available from advertisement content database 34 that the end user may be interested in viewing. Advertisement analyzer 42 also accepts queries from the end user to help locate advertisement content of interest to the end user. For example, if an end user has performed a number of searches recently to locate information on fixing a car, advertisement analyzer 42 can preload advertisement contents, such as plural advertisement movies by plural car repair shops, and present the preloaded advertisements to the end user for the end user to select if the end user so desires. Alternatively, the end user can indicate a search for advertisements about new cars so that advertisement analyzer can prioritize car advertisement contents based upon information available at client computer 12 about the end user. If, for example, the end user listens to country music, then pickup trucks might get priority. If, on the other hand, the end user watches NASCAR races, muscle cars might get priority. In any event, the end user is empowered to select advertisements for viewing that are relevant to the end user with the advertisement analyzer available to help in the selection process. Similarly, advertising entities 38 can focus advertisement content on an interested consumer to convey compelling facts rather than focusing on attracting attention. In this manner, advertisement contents become more efficient at providing useful information for interested consumers so that the process of communicating advertisement content to consumers becomes more useful for both advertisers and consumers.

Once an end user consumer selects an advertisement content from the plural advertisement contents, the end user can view the selected advertisement content at display 20, television 22, or any appropriate presentation device, such as by communicating with display devices through a wireless local area network. The advertisement content can include any type of multimedia content, such as a conventional television commercial movie shown during a commercial break, a slide show, a document, a brochure or any content that communicates advertising information to promote a product, manufacturer, political cause, charity, etc. . . . The end user gets to select a time to view the selected advertisement content that is convenient for the end user. For example, a housewife might watch advertisements while doing housecleaning or cooking. In one embodiment, a consumer can earn higher points for viewing a given advertisement content based upon the time that the consumer selects to view the advertisement content. For example, an advertisement for food might offer more points for the consumer to earn if the consumer views the advertisement during time periods when the consumer is hungry or likely to be hungry, and an advertisement for beer might offer more points when consumers are more likely to consumer beer, such as during the time of day that football games are played. A consumer might watch advertisements while shopping for goods, either on line or at a retail location, in order to make a more informed purchase decision. The timing of the presentation of advertisement content is independent of the timing of the presentation of entertainment content that the end user is authorized to view in exchange for watching advertisement contents. Thus, a consumer endures less inconvenience for watching advertisement content yet gets the benefit for watching advertisement contents when convenient for the consumer by selecting when to watch entertainment content and then watching the entertainment content without interruptions from advertisement content commercial breaks.

A verifier 44 executing on client computer 12 verifies that the consumer has watched selected advertisement content with a predetermined attention level. If the consumer has watched the selected advertisement content with a predetermined attention level, then verifier 44 sends a message to server 14 to award points to the consumer end user for the presentation and observation of the selected advertisement content. In one embodiment, verifier 44 is limited in its communication with server 14 to provide only verification of presentation of selected advertisement content without providing the information used to establish verification. In this manner, verifier 44 can access detailed information available from sensors of client computer 12 without privacy concerns for the end user of client computer 12. For example, verifier 44 uses images captured by camera 28 and/or sounds captured by microphone 30 to analyze the attention of the end user consumer to the presentation of advertisement content. For instance, if the end user is not in the view of the camera or has a profile looking away from the presentation, verification is not provided. In one embodiment, verifier 44 stops the presentation of advertisement content when an end user is paying inadequate attention and issues a voice notification from a speaker of client computer 12 that the end user must watch the advertisement content to obtain an award of points. A similar function can aid the consumer when the consumer watches entertainment content by automatically pausing the entertainment content when the consumer is not viewing the content, such as when the user leaves the view of the camera or the microphone picks up the sound of a crying baby. Sensors can also verify the identity of the end user who is watching the advertisement content, such as by applying voice or image recognition.

Verifier 44 can also provide verification based upon one or more inputs made by an end user in response to the advertisement content. For example, an end user consumer looking for a new car might view a number of car advertisement contents, such as plural movie commercials by plural car manufacturers. When the consumer decides to pursue further information about one of the cars presented by the plural advertisement contents, the consumer interacts with the advertisement content of the car of interest to contact the advertising entity 38 associated with the advertisement content. Verifier 44 analyzes inputs made by the consumer at client computer 12 to determine that an inquiry for additional information to advertising entity 38 is authentic. Based upon the authenticity of the inquiry, verifier 44 provides verification of the advertisement contents to server 14. For example, if consumer end user activity indicates the viewing of new car advertisements and the consumer selects less than all of the new car advertisements to interact with, verification may be found because the searching activity of the consumer indicates that the consumer is narrowing down between several choices. In addition, a consumer end user may be awarded additional bonus points for establishing commercial interactions with an advertising entity, such as to purchase a product or inquire for additional information. In alternative embodiments, other types of inputs can provide verification of presentation of advertisement contents, such as inputs to an advertising entity survey, inputs to request additional information related to presentation of an advertisement content or analysis of inputs based upon historical inputs by the end user that indicates adequate attention paid by the end user consumer to presentation of advertisement contents. In one embodiment, inputs are made by voice commands from an end user that are analyzed by a speech recognizer 46 and transformed to text for communication to an advertising entity 38.

Verifier 44 communicates verification of presentation of advertisement content from client computer 12 to server 14 so that a tracking module 48 can track points awarded to consumers for views of advertisement content. Tracking module 48 inquires with advertisement content database 34 to obtain a point value associated with presentation of the verified advertisement content and stores the awarded points in a points database 50 by reference to the end user consumer of client computer 12. For example, watching a car movie advertisement might give an end user an award of 100 points while inquiring with the advertising entity of the car for a price quote might award a bonus of 25 points. Subsequent feedback from the advertising entity that the consumer purchased a car based upon the inquiry can result in additional bonus points. An advertising entity 38 determines points awarded for a given advertisement content with a higher points award likely to draw more views for the advertisement content at a greater expense to the advertising entity 38. An advertising entity can lower its advertising expense by generating advertising content of greater interest to consumers so that smaller point awards will still draw views. For example, consumers are more likely to view humorous advertisements prepared for the Super Bowl than ordinary advertisements made for everyday television commercials. Alternatively, an advertising entity can lower its advertising expense by narrowly targeting advertisement contents so that consumers will watch the most relevant content with a greater chance per view that a consumer will respond to an advertisement content. Thus, an economic incentive exists for an advertising entity to provide entertaining and relevant advertisement content that is less likely to waste a consumer's time.

Once an end user consumer builds sufficient points in point database 50, the end user consumer can exchange the points to obtain authorization to view entertainment content. The consumer selects an entertainment content, such as a movie or sitcom, from plural entertainment contents available from entertainment content database 36 for presentation at consumer location 32, such as with a selection through client computer 12 for presentation at display 20 or television 22. Tracking module 48 retrieves the number of points associated with the end user consumer from points database 50 and compares the points available for the consumer to exchange with a point cost associated with an entertainment content selected by the end user as stored in entertainment database 36. For example, a recently released movie might have a relatively high point cost, such as equivalent to viewing a half-dozen advertisement content movies, while a re-run television sitcom might have a relatively low point cost, such as equivalent to viewing a single advertisement content movie. If an end user consumer has points at least equal to the point cost of a selected entertainment content, tracking module 48 authorizes presentation of the selected entertainment content to the consumer, such as by streaming or other communication techniques, and reduces the consumers points in points database 50 by the point cost of the selected entertainment content. Entertainment content owners have control over the price of an entertainment content by setting the point cost of the entertainment content. Advertisement entities 38 pay the operator of tracking module 48 for advertising content verified as presented to an end user consumer based upon the points awarded to the end user consumer for watching the advertisement content. Entertainment entities 40 get paid by the operator of tracking module 48 based upon the views of an entertainment content and the point cost of the entertainment content. The operator of tracking module 48 makes a profit based upon the revenue raised from advertising entities 38 minus the cost paid to entertainment entities 40.

In one example embodiment, entertainment contents provided by server 14 is a movie streaming website that streams movies, such as Animal House, to a consumer location 32. In response to a selection by an end user of Animal House as entertainment content from plural entertainment contents of database 36, server 14 allows an end user to purchase a view of the movie with money, to have the movie streamed with commercial breaks that have advertisement contents or to apply points of the end user from database 50 so that the movie streams free of a money charge and free of advertisements in exchange for points of the end user. In one embodiment, a consumer without sufficient points to see an entertainment content in its entirety might select to see a portion of the entertainment content advertisement free for the value of points available to the consumer and a portion with advertisements included in commercial breaks. This allows the consumer to start viewing entertainment content immediately even if the consumer lacks points to view an entire entertainment content rather than having to pause to view additional advertisement contents.

In an alternative embodiment, entertainment content is a news website that streams news stories as movies to a consumer location through a website. The website includes banner advertisements disposed around a video window and movie advertisements inserted before each news story. The website has an advertisement point option specific to the website that allows a consumer to select and view advertisements at the website for points exchangeable only at that website. Consumers who select and view advertisement contents to earn points are then provided with access to the entertainment content of the news website, such as news stories, that is streamlined to be absent of advertisements, including the banner advertisements and the movie advertisements. The consumer creates greater value for the news website by viewing advertisements selected by the consumer so that the consumer has to view fewer advertisements to obtain access to the entertainment content than the consumer would have to view if advertisements were included in the entertainment content. The news website receives greater value with higher advertising revenue for fewer presentations of advertisement content and the consumer receives the news in less time than if the consumer had to watch an advertisement before each news story.

In another alternative embodiment, a mom selects advertisements to view to help her purchase clothes for her children. The mom earns points for selecting and viewing clothes advertisements and bonus points for interacting with an advertising entity, such as by purchasing clothes from interactions that start with an advertisement. When her children come home from school, the mom exchanges the points for access to educational entertainment content to show to the children without advertising content inserted in the entertainment content. In this way, the mom gets value from advertisements by shopping with relevant information presented by advertising entities and gets value from the entertainment content without her children being exposed to advertisements about sugar-laced cereals. Advertising entities get value by spending advertisement dollars on a consumer who will actually use advertisement information. The advertisement entities get to tailor a message for the consumer that would not ordinarily be available if the consumer used a search engine to shop. In one embodiment, the advertisement analyzer on the mom's client computer tracks that the mom shows the entertainment content to her children at predetermined times and provides the mom with a warning if the mom lacks sufficient points to watch the expected entertainment content so that the mom can view advertisement contents to build points before showtime.

In another alternative embodiment, a consumer with a smart phone enters a retail store and sees a QR code for the day's advertisement content of the retailer. The consumer takes a picture of the QR code, which brings up a browser to the retailer's website. The consumer watches a video of the day's advertisement content to earn points for viewing the advertisement and in the process, obtains valuable information about sales at the retailer for the day. The points allow the consumer to skip advertisements for his favorite sitcom that evening, which streams to his home television without commercial breaks having advertisement content or, alternatively, with a brief break or a banner from the retailer as the sponsor of the entertainment content. The retailer spends advertising dollars to sponsor the entertainment content; however, the retailer obtains value from the advertising dollars by directly communicating a message about sales to the consumer at an optimal time. Verification that the consumer viewed the advertisement content can be based upon the GPS location from the smart phone or a location provided by the QR code.

In another alternative embodiment, the consumer selects a live broadcast as entertainment content that has commercial breaks added as part of the broadcast. The consumer elects to spend points earned from watching advertisement contents to have the live broadcast sent without advertisement content in the commercial breaks. Instead of including advertisement content in commercial breaks, the advertisement content that would be sent to the consumer as part of the live broadcast is replaced with additional premium entertainment content. For example, rather than watching beer commercials at half time, the consumer gets switched to another game. Alternatively, instead of watching sugar-laced cereal commercials during breaks of a live child educational program, the consumer receives a game on ABC's, counting or other educational games targeted to the age group expected to watch the live show. As another example, instead of receiving commercials during a break in a news show, the consumer receives a summary of current news items displayed on the screen.

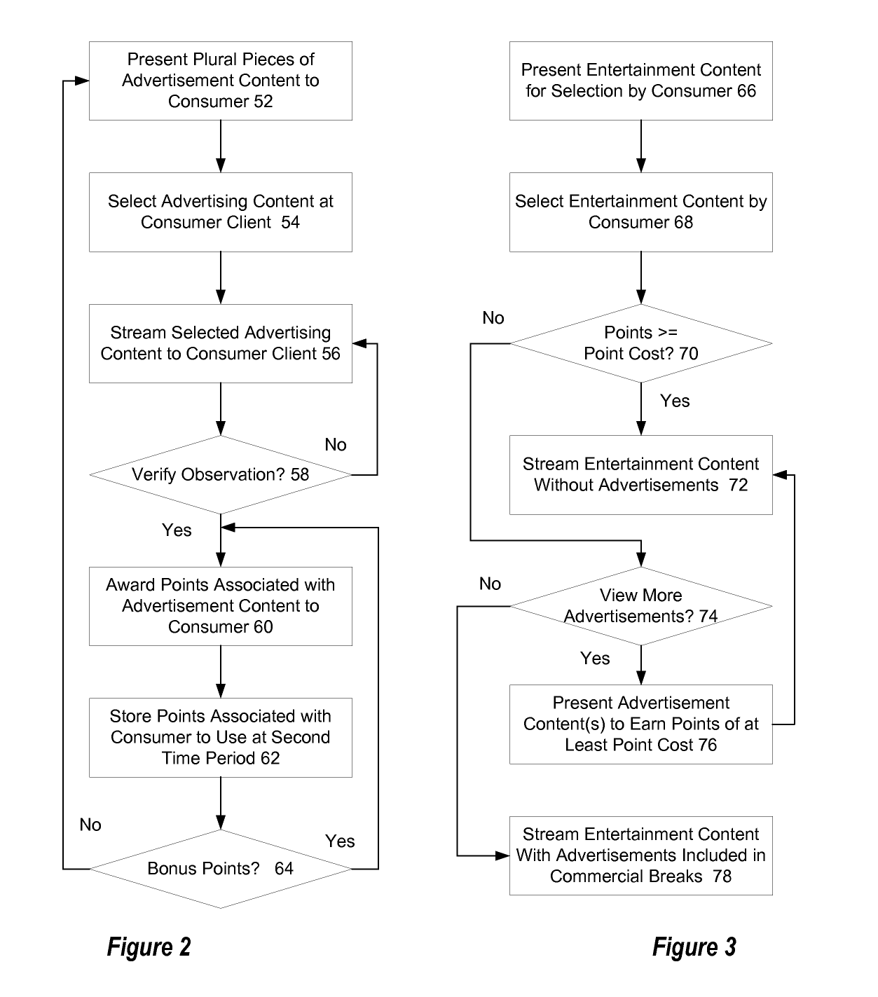

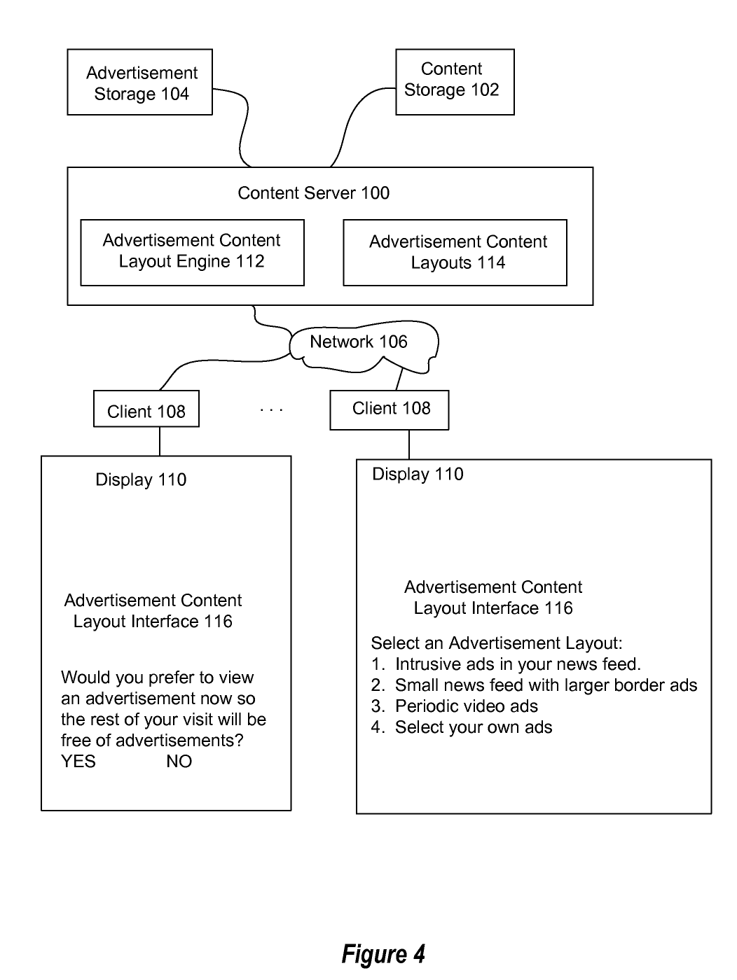

Referring now to FIG. 2, a flow diagram depicts a process for a user to select advertisements to earn points. The process begins at step 52 with the presentation of plural advertisement contents for selection by an end user of an advertisement content for observation by the end user. Each of the plural advertisement contents is a discrete advertisement for promotion of a good, manufacturer, cause, charity, politician, etc. . . . , and has an associated point value. In one embodiment, the point value for an advertisement can vary based on factors, such as the time of day, the region of the IP address of the consumer, a predicted authenticity of the consumer's desire to view the advertisement content, past behavior of the consumer, purchasing power of the consumer, the number of views by the end user of that advertisement etc. . . . The point value for presentation of an advertisement content to a particular consumer may be presented to that consumer when the consumer considers the advertisement content for selection. At step 54, the end user selects an advertisement content from plural advertisement contents based on the end user's own interests and needs. In one embodiment, a rating system provides the end user with quality information about the advertisement, such as the number of views of the advertisement or end user rankings of the advertisement, to aid the end user in selection of a quality advertisement content. Good quality advertisements obtain more views by providing entertaining or particularly informative advertisement content, which tends to increase the overall quality of advertisements available for consumers to view.

At step 56, an end user consumer initiates streaming of a selected advertisement content to a display for viewing by the end user consumer. In alternative embodiments, the advertisement content can download to the end user's client computer to support watching while off-line, such as on an airplane trip. At step 58 a determination is made of whether or not to verify observation of the advertisement content by the end user. If not verified, the process returns to step 56 to provide the end user with another opportunity to view the advertisement content. If verified, the process continues to step 60 to award points to the end user for watching the advertisement content. For example, verification is made with sensors on the end user consumer's client computer, such as a camera that observes the end user, without sending the sensed information from the client computer so that the end user's privacy is protected. At step 62, the points awarded to the end user are stored so that the end user can exchange the points at a future time to obtain entertainment content free of advertisements. In one alternative embodiment, the points are stored in a secure location of the end user consumer's client computer system. At step 64, a determination is made of whether the end user has earned a bonus, such as by making a purchase or other interaction with the advertising entity that sponsored the advertisement content viewed by the end user. The process then returns to step 52 to present additional advertisement content. The selection of advertisement content and awarding of points for observing advertisement content are performed in a first time period that is independent of the selection and presentation of entertainment content by exchanging awarded points.

Referring now to FIG. 3, a flow diagram depicts a process for a user to select entertainment content by exchanging points earned from observing advertisement content. At step 66, plural entertainment contents are presented to the end user for selection of one or more entertainment contents. At step 68, the end user selects one or more of the entertainment contents for presentation. At step 70, a determination is made of whether the points awarded to the end user for presentation of advertisement content are sufficient to meet the point cost of the selected entertainment content. If yes, the process continues to step 70 to reduce the points of the end user by the point cost of the selected entertainment content and the entertainment content is communicated for presentation to the end user, such as by streaming, without advertisement content included in the entertainment content, or alternatively with less advertisement content included with the entertainment content as reflected by the point cost. If at step 70, the determination is that the end user has less points than the point cost, the process continues to step 74 to allow the end user to decide whether to view more advertisement content before viewing the entertainment content so that the entertainment content will be presented without interruptions by advertisement content. If yes, the process continues to step 76 to present additional advertisement content, such as by selection of the end user or by random selection, so that the end user earns enough points to meet the point cost. The process then continues to step 72 to present the entertainment content in exchange for points of the end user equal to the point cost of the entertainment content. If at step 74 the end user decides to view the entertainment content with commercial breaks having advertisement content instead of watching advertisement content separately, the process continues to step 78 to stream the entertainment content with advertisement content. The selection of entertainment content and exchange of points earned from observing advertisement content for the presentation of entertainment content are performed in a second time period that is independent of the selection and presentation of advertisement content so that an end user earns points and exchanges points in separate and independent transactions.

In one alternative embodiment, end users are empowered to select an advertisement content layout for presentation of information at a client of the end user from plural available advertisement content layouts. The selection of an advertisement content layout from plural advertisement content layouts allows the end user to control a tradeoff at the end user's client of the quantity, quality, display positioning, timing, type and other factors for advertisements presented at a display of the client in exchange for the quantity, quality, display positioning, timing, type and other factors for entertainment content presented at the display. For example, social media users alter the arrangement of advertisements relative to a social media news feeds in either or both of positional and temporal dimensions. Each social media user selects an advertisement content layout most acceptable for herself to provide an improved user experience at each of plural clients. If a particular end user elects to view high quality advertisement content, then the news feed is presented to her with fewer of such advertisements; if another end user elects to view low quality advertisements, then the news feed is presented to him with a greater number of such advertisements. When an end user selects an advertisement content layout with high quality advertisements, the social media website achieves advertisement revenue goals by presenting fewer advertisements that are of greater value to advertisers and the end user consumes entertainment content in the form of a social media news feed with fewer advertisement distractions. Each social media end user is thus able to personalize how advertisements are presented at his or her own client display.

Referring now to FIG. 3, a block diagram depicts an example embodiment of a system for user-selected advertisement content layout. A content server 100 provides entertainment content from content storage 102 and advertisement content from advertisement storage 104 through a network 106 for presentation at clients 108 having displays 110. The storage and communication of information is provided by memory and processing resources of content server 100, clients 108 and network 106 to transform information from advertisement storage 104 and content storage 102 into images for presentation at displays 110 according to selections made by end users. In alternative embodiments, entertainment and advertisement contents may be sent from a plurality of server and storage devices to clients 108, such as may be provided by networked content servers having a storage area network and by advertisement content services like DOUBLECLICK.

In order to provide end user entertainment content consumers with control over the presentation of advertisement contents at a client 110, an advertisement content layout engine 112 retrieves plural available advertisement content layouts 114 and presents the available advertisement content layouts to the end user entertainment content consumer for a selection. The end user entertainment content consumer selects one of the advertisement content layouts 114 for use by advertisement content layout engine 112 in sending advertisement and entertainment contents to the client 108 and display 110 of the end user. In alternative embodiments, advertisement content layout engine 112 includes distributed modules that accomplish selection of advertisement content layouts by executing on one or move processing and memory resources of content server 100, clients 108, and other resources.

In one embodiment, the end user is presented with an opportunity to select an advertisement content layout 114 having a temporal dimension upon initial contact by the end user with content server 100. For example, the end user content consumer is presented at display 110 with the question “Would you prefer to view an advertisement now so the rest of your visit will be free of advertisements?” If the end user entertainment content consumer selects “no” at display 110, then client 108 communicates the “no” to content server 100, which responds by using a default advertisement content layout 114 that inserts advertisements into presentation of entertainment content. For example, the default advertisement content layout 114 presents advertisements within a social media news feed of the end user entertainment content consumer for presentation at display 110. If the end user entertainment content consumer selects “yes,” then the yes is communicated to advertisement content layout engine 112 for selection of an advertisement content layout 114 having a temporal dimension. For example, the temporal advertisement content layout 114 presents a video window at display 110 to show an advertisement movie at display 110 in response to the “yes” selection and then removes the video window from display 110 to present entertainment content at display 110 without any advertisements. The temporal advertisement content layout can define an amount of entertainment content that the end user entertainment content consumer receives before additional advertisements are presented. For example, the end user can receive entertainment content without advertisement content for a time period or a data download metric based upon the type of advertisement movie viewed. For instance increased awards of greater amounts of advertisement-free entertainment content can be provided if the end user selects the advertisement, verifies viewing of the advertisement, interacts with the advertisement, views a lengthier advertisement, views the advertisement in a large window, etc. . . . When the time period or download metric for entertainment content presentation is met, advertisement content layout engine 112 offers the end user another opportunity to view an advertisement.

In an alternative embodiment, advertisement content layout engine 112 provides each of plural end users with alternatives to select a personal configuration for future use at the content website. For example, the end user can accept a default configuration with intrusive advertisements included in a social media news feed, a layout with a positional dimension that has a smaller display area for content without including advertisements in the content, a temporal dimension with periodic video advertisements or a selection by the end user of advertisements to view. Once the end user selects a personal advertisement content layout 114, the personal layout is saved so that advertisement content layout engine 112 automatically uses the selected advertisement content layout when the end user accesses content server 100. The availability of several advertisement content layouts empowers the end user to control presentation of entertainment and advertisement content at the end user's display. If the end user does not mind intrusive advertisements, then insertion of advertisements in the news feed will provide an acceptable default. If the end user views the entertainment content portion of the display as sacred, then the end user can accept larger and more visible border advertisements in exchange for freedom from advertisements served in the news feed. If the end user is willing to view a high quality advertisement, such as a movie, then viewing the higher quality advertisement entitles the end user to less intrusion when viewing entertainment content—a win-win proposition for the social network website, its advertisers and the entertainment consumer. If the end user is willing to search out advertisements of interest to the end user, he can save an award of points as set forth above. In the example embodiment, one advertisement content layout lets a social media website help the end user search for advertisement content by visiting the social media pages of advertisers or by “friending” advertisers so that the end user controls the type of advertisements that the end user views and obtains award points when advertiser “friends” send news to the end user's news feed or otherwise communicate advertisement contents to the end user. For instance, an end user who surfs obtains award points for viewing entertainment content by selecting a surf board manufacturer advertisement movie and additional points for friending the surf board manufacturer and viewing advertisements from the surf board manufacturer over time, such as through a news feed. The award points essentially allow the end user to view entertainment content in the form of a social media “friends” feed without advertisements other than advertisements of advertisers acceptable to the end user.

In alternative embodiments, other types of entertainment content providers may use advertisement content layout selection by end users. For example, a cable television channel can present an advertisement content layout interface 116 before a television show that allows the end user to view commercials selected by an end user before a television show begins so that the end user is not interrupted by the advertisements during the television show. Alternatively, the temporal advertisement content layout for the television show is altered by reducing the length of advertisement interruptions where an end user selects advertisements to view. The content provider can narrow advertisements selectable by an end user so that more expensive advertisement space is sold to advertisers for a subset of end users having a selected quality. For example, surf board advertisements are not made available for selection by end users who live in the Midwest so that the surf board manufacturer has an increased value proposition when its advertisements are selected by end users who are associated with localities that surf.

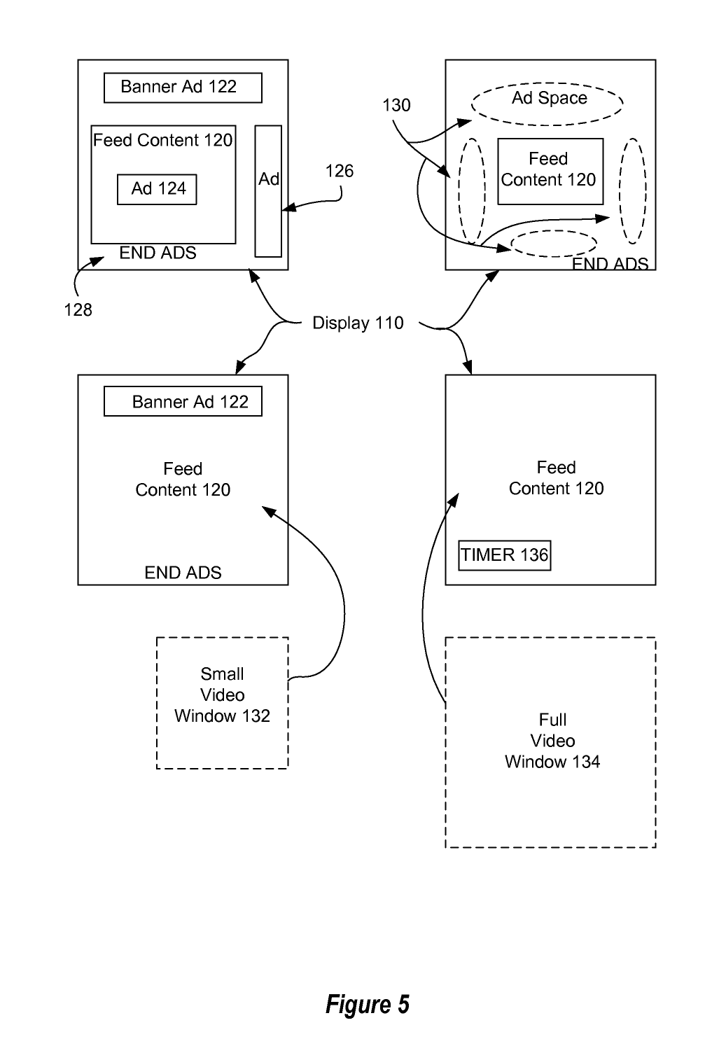

Referring now to FIG. 5, four examples of advertisement content layouts selectable by an end user and presented at displays 110 are depicted. Each of plural end users can individualize presentation of information at a client interfaced with the content website by selecting an advertisement content layout for each end user. In one example, a default advertisement content layout is depicted for a social media website having a feed content 120 presented at display 110 with a banner advertisement 122 above the feed content 120, an intrusive feed content advertisement 124 presented within feed content 120, and a side advertisement 126 presented to the side of feed content 120. The default advertisement content layout includes an “END ADS” link that an end user can select to view an advertisement content layout interface 116 for selecting an alternative advertisement content layout. In the example embodiment, the feed content is a social media feed of “friend” comments, however, other types of entertainment content may presented within the feed content space instead of the feed content of a social media website.

One example of an alternative advertisement content layout selectable by an end user has plural advertisement spaces 130 defined in positions of display 110 and a reduced space for feed content 120. Although advertisement spaces 130 offer space for an increased number and size of advertisement contents, the smaller-sized feed content 120 is advertisement free, such as without advertisements inserted in a social media friends feed. Another example of an alternative advertisement content layout uses positional and temporal dimensions for presenting advertisements by overlaying a small video window 132 over display 110 to periodically present advertisement movies. Small video window 132 offers the end user an opportunity to move the advertisement movie to the side of feed content 120 so that the end user can continue to view feed content 120 while the advertisement move plays. Because the end user has a better chance of ignoring an advertisement movie shown in small video window 132, making the advertisement content layout less valuable, a banner advertisement 122 is also depicted. To ensure presentation of advertisement videos at appropriate intervals, the end user may download an application to his client to manage presentation of small video window 132, such as by preventing the end user from hiding the movie advertisement completely when it is shown.

Another example of an alternative advertisement content layout selectable by an end user presents a full video window 134 which covers over feed content 120 when an advertisement movie is presented. Because the end user has entertainment content interrupted by full video window 134, such as by an application executing on the end user's client, the end user is awarded a greater amount of entertainment content after the advertisement movie is viewed in the full video window 134 compared with the award from watching an advertisement movie in small video window 132. A timer 136 indicates to the end user how much more entertainment content the end user can view before additional advertisement content is presented. For example, the end user is given a time period of advertisement free viewing or an estimate of time left until a download metric is met based upon the end user's rate of downloading information. In one embodiment, the timer includes a reminder of the advertiser who sponsored the current viewing of entertainment content, such as the identity of the advertiser associated with the advertisement content viewed by the end user to support the current advertisement—free viewing by the end user of entertainment content. Once the timer 136 expires, the end user is presented with an opportunity to select additional advertisement movies, with automatic presentation of an advertisement movie, or automatic transition to a default advertisement content layout, such as a layout having advertisements inserted into feed content. For example, the application running on the client alters the advertisement content layout at the client when the timer expires by applying the default layout instead of the temporal advertisement content layout. Although the example embodiment presents advertisement content layouts in a social media website having a news feed, alternative embodiments include any type of website or television presentation having positional or temporal advertisement content layouts selectable by an end user, such as banner advertisements and commercial breaks.

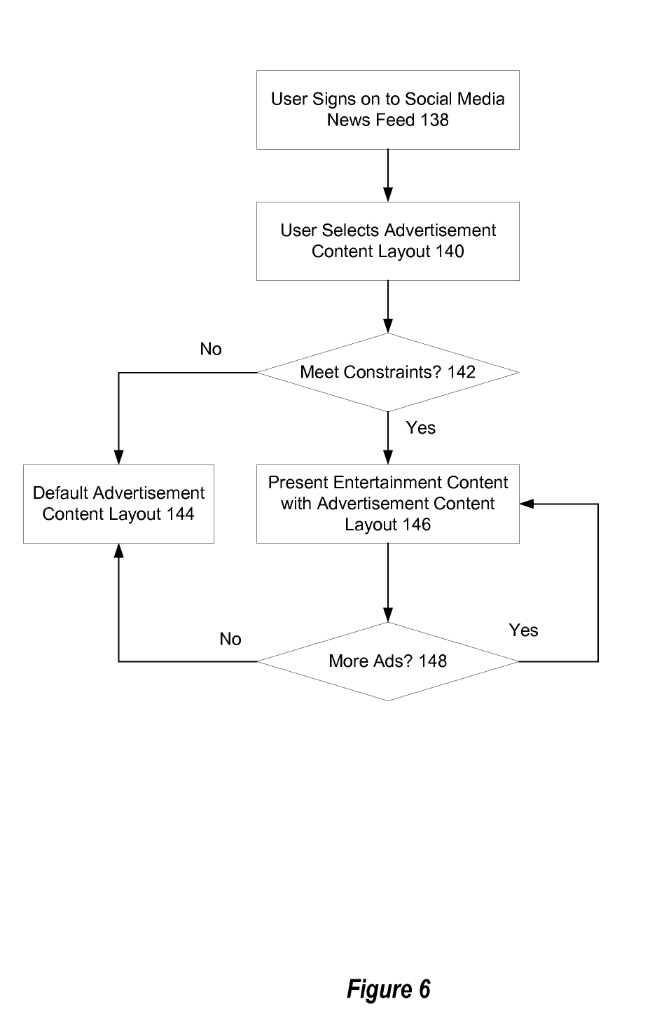

Referring now to FIG. 6, a flow diagram depicts one example of a process for selection by an end user of an advertisement content layout from plural advertisement content layouts. The process begins at step 138 when an end user entertainment content consumer signs on to a social media news feed, such as to view inputs by friends. At step 140 the end user is presented with plural available advertisement content layouts and selects one of the advertisement content layouts for access to the social media news feed. In one embodiment, the selection results in a personalized configuration for the end user so the end user is provided with the selection in subsequent visits to the website. In another embodiment, the selection results in a personalized configuration for the end user anytime the end user accesses a website that is served with advertisements by an advertisement service, such as where points for viewing advertisements are pooled by the advertisement service. At step 142, a determination is made of whether the end user has met constraints for the selected advertisement content layout that will allow the end user to view entertainment content. For example, if the end user has selected a layout that requires verification of the end user viewing an advertisement and the end user has not performed a verified viewing of an advertisement, the process continues to step 144 to present advertisements and entertainment content with the default advertisement content layout. If at step 142 the end user has met the constraints, the process continues to step 146 to present entertainment content with the advertisement content layout selected by the end user. At step 148, a determination is made of whether the end user still meets the constraints or must view additional advertisements. If the constraints are met for the currently selected advertisement content layout, the process returns to step 146. If the constraints lapse at step 148, the process continues to step 144 to present information with the default content layout. The end user can initiate a change from the default advertisement content layout by selecting an “END ADS” icon from his display to go to an advertisement content layout interface.

Although the present invention has been described in detail, it should be understood that various changes, substitutions and alterations can be made hereto without departing from the spirit and scope of the invention as defined by the appended claims.

What is claimed is:

1. A method for presenting advertisement content to a consumer, the method comprising:
selecting by the consumer an advertisement content layout from plural advertisement content layouts;
sending advertisement content through a network to the consumer for presentation at a client; and
in response to the selecting by the consumer, presenting the advertisement content at the client with the selected advertisement content layout.

2. The method of claim 1 wherein the in response to the selecting by the consumer, presenting the advertisement content at the client further comprises altering the presenting of entertainment content at the client based upon the selected advertisement content layout.

3. The method of claim 1 wherein the plural advertisement content layouts comprise at least a temporal advertisement content layout and a positional advertisement content layout and wherein selecting by the consumer comprises selecting the temporal advertisement content layout, the method further comprising:
presenting the advertisement content at the client with the temporal advertisement content layout;
presenting entertainment content at the client after the presenting the advertisement content; and
presenting an indicator with the entertainment content, the indicator indicating an amount of entertainment content that the consumer can view until another advertisement content is presented at the client.

4. The method of claim 3 wherein presenting entertainment content at the client further comprises presenting the entertainment content without advertisement content included in the entertainment content.

5. The method of claim 1 wherein the advertisement content layout comprises an advertisement video presented at the client for a predetermined time in exchange for presentation of entertainment content at the client for a predetermined award time without advertisement content during the predetermined award time.

6. The method of claim 5 further comprising:
presenting the advertisement video at the client for the predetermined time;
removing the advertisement video from presentation at the client after the predetermined time;
presenting the entertainment content without advertisement content for the predetermined award time; and
presenting the entertainment content with a default advertisement content layout after the predetermined award time.

7. The method of claim 6 wherein the entertainment content comprises a social media news feed and the default advertisement content layout comprises advertisement content inserted into the social media news feed.

8. The method of claim 6 further comprising:
verifying viewing of the advertisement video by the content consumer; and
in response to verifying, adding time to the predetermined award time.

9. The method of claim 6 further comprising:
presenting the entertainment content for a first predetermined award time in response to presenting the advertisement video in a window having a first size; and
presenting the entertainment content for a second predetermined award time in response to presenting the advertisement video in a window having a second size;
wherein the first size is smaller than the second size and the first predetermined award time is smaller than the second predetermined award time.

10. A method for presenting advertisement content, the method comprising:
defining plural advertisement content layouts, each advertisement content layout having one or more predetermined advertisement content locations relative to entertainment content;
selecting with each of plural clients through a network an advertisement content layout from the plural advertisement content layouts for each of the plural clients; and
presenting at each of the plural clients advertisement content at one or more advertisement content locations relative to entertainment content based upon the advertisement content layout selected for each client.

11. The method of claim 10 further comprising:
defining a default advertisement content layout having advertisement content locations intermingled with entertainment content; and
presenting advertisement content with the default advertisement content layout at one or more clients that do not select an advertisement content layout from the plural advertisement content layouts.

12. The method of claim 11 wherein one of the plural advertisement content layouts comprises presenting an advertisement video window having advertisement video content, the advertisement video window presented over the entertainment content for a predetermined time and removing the advertisement video window from over the entertainment content after the predetermined time, the removing for a predetermined award time.

13. The method of claim 12 wherein the one of the plural advertisement content layouts further comprises presenting the entertainment content without any advertisement content during the predetermined award time.

14. The method of claim 12 further comprising:
verifying observation of the advertisement content by an end user of the client during the presenting an advertisement video window content; and
in response to verifying, increasing the predetermined award time.

15. The method of claim 12 further comprising:
presenting an indicator with the entertainment content, the indicator providing an indication of expected expiration of the predetermined award time.

16. The method of claim 15 wherein presenting an indicator further comprises:
presenting instructions to view advertisement video content as a condition for viewing entertainment content;
if advertisement video content is viewed in response to presenting instructions, then presenting the entertainment content without advertisement content; and
if advertisement video content is not viewed in response to presenting instructions, then presenting the entertainment content with advertisement content using the default advertisement content layout.

17. A system for presenting advertisement content, the system comprising:
an advertisement server having plural advertisement contents accessible from memory and operable to communicate the advertisement contents to plural clients through a network; and
an advertisement content layout engine executing on the server and operable to present advertisement contents according to a selected of plural advertisement content layouts, the advertisement content layout engine further operable to provide each of plural clients with plural advertisement content layouts, to accept an advertisement content layout selection from each of the plural clients and to present advertisement contents at each of the plural clients according to the advertisement content layout selection of each client.

18. The system of claim 17 wherein the plural advertisement content layouts comprise a first advertisement content layout having advertisement content inserted into a social media news feed and a second advertisement content layout having advertisement content separate from the social media news feed.

19. The system of claim 18 wherein the second advertisement content layout comprises an advertisement movie presented independent of entertainment content.

20. The system of claim 19 wherein the second advertisement content layout further comprises presentation of entertainment content without advertisement content for a predetermined time.
